(19) United States
(12) Patent Application Publication
(10) Pub. No.: US 2011/0223323 A1
(43) Pub. Date: Sep. 15, 2011

(54) PROCESS FOR PRODUCING SCINTILLATORS

(75) Inventors: Yoshihiro Ohashi, Tokyo (JP); Nobuhiro Yasui, Yokohama-shi (JP); Toru Den, Tokyo (JP)

(73) Assignee: CANON KABUSHIKI KAISHA, Tokyo (JP)

(21) Appl. No.: 13/027,467

(22) Filed: Feb. 15, 2011

(30) Foreign Application Priority Data
Mar. 12, 2010 (JP) 2010-056616

(51) Int. Cl. B05D 5/06

(52) U.S. Cl. 427/157

(57) ABSTRACT

A process for producing a scintillator including the steps of producing a CsI columnar film formed of columnar CsI crystals by a deposition method, and adding an emission center to the CsI columnar film by disposing the CsI columnar film and an emission center material in a non-contact state in a closed space, heating the CsI columnar film in the range of not less than a sublimation temperature or evaporation temperature of the emission center material and not more than a temperature at which a columnar shape of the CsI columnar film can be maintained, and heating the emission center material at a temperature of not less than a sublimation temperature or evaporation temperature thereof.

### BACKGROUND OF THE INVENTION

1. Field of the Invention

The present invention relates to a process for producing a scintillator.

2. Description of the Related Art

Nowadays, as a scintillator for use in an indirect type X-ray detector, CsI:Tl in which thallium (Tl) is added as an element serving as an emission center (hereinafter, merely expressed as an “emission center”) to columnar cesium iodide (CsI) having an optical propagation function is widely used. CsI:In using indium (In) as the emission center can also be used as a scintillator.

A CsI columnar film having an added emission center (hereinafter, expressed as “emission center added CsI”) is produced by an ordinary binary deposition method as shown in Japanese Patent Application Laid-Open No. 2008-111789. Deposition is performed while CsI and an emission center material having different sublimation temperatures are separately heated to control each deposition rate separately. In this case, in order to ensure the film thickness uniformity within a plane and the concentration uniformity of the emission center, the distance between a deposition source and a film deposition region needs to be at least 1-fold or more of the length of the shorter side of the film deposition region. A material emitted from the deposition source onto a region other than the film deposition region is wasted. For this reason, use efficiency of the material deposited on the film deposition region based on a supplied raw material was as low as 20% or less.

As mentioned above, such a problem in producing an emission center added CsI columnar film has been that a small amount of CsI and the emission center material as the supplied raw material is deposited on the film deposition region and thus the use efficiency of the materials is low. Particularly, because a rare element is often used for the emission center material, a production process in which an emission center material can be added at higher material use efficiency has been desired from the aspects of costs and environments.

### SUMMARY OF THE INVENTION

The present invention has been made in consideration of such background art, and an object of the present invention is to provide a process for producing an emission center added CsI columnar film having high use efficiency of a material.

The above problems can be solved with the following configuration according to the present invention.

A process for producing a scintillator according to the present invention comprises: producing a CsI columnar film formed of columnar CsI crystals by a deposition method, and adding an emission center to the CsI columnar film. In adding an emission center to the CsI columnar film, the CsI columnar film and an emission center material are disposed in a non-contact state in a closed space, the CsI columnar film is heated in the range of not less than a sublimation temperature or evaporation temperature of the emission center material and not more than a temperature at which a columnar shape of the CsI columnar film can be maintained, and the emission center material is heated at a temperature of not less than the sublimation temperature or evaporation temperature thereof.

According to the present invention, the process for producing an emission center added CsI columnar film having high use efficiency of a material can be provided.

Further features of the present invention will become apparent from the following description of exemplary embodiments with reference to the attached drawings.

### BRIEF DESCRIPTION OF THE DRAWINGS

FIG. 1 is a schematic view illustrating a disposition relationship between an emission center material and a CsI columnar film at a step of adding an emission center according to the present invention.

FIG. 2 is a second schematic view illustrating a disposition relationship between an emission center material and a CsI columnar film at a step of adding an emission center according to the present invention.

FIG. 3 is a schematic view illustrating a disposition relationship among a CsI deposition source, a CsI columnar film, and an emission center material when a step of producing a CsI columnar film and a step of adding an emission center are conducted in the same closed space according to the present invention.

FIG. 4 is a schematic view illustrating a disposition relationship among a feed port of an organic gas, a discharge port thereof, and a CsI columnar film in a case of adding an emission center using the organic gas containing the emission center at a step of adding the emission center according to the present invention.

FIG. 5 is a schematic view illustrating a disposition relationship at the time of performing deposition with a small distance between a deposition source and a film deposition region at a step of producing a CsI columnar film according to the present invention.

FIG. 6 is a diagram illustrating an emission spectrum and an excitation spectrum in each case where using a different emission center material (InI, InBr, InCl) in Example 1 according to the present invention, an emission center is added at a fixed heating temperature.

FIG. 7 is a diagram illustrating an emission spectrum and an excitation spectrum in each case where using InI as an emission center material, an emission center is added at a different heating temperature in Example 1 according to the present invention.

FIG. 8 is a diagram illustrating an emission spectrum and an excitation spectrum in each case where using InI as an emission center material, an emission center is added under a different pressure at a fixed heating temperature in Example 1 according to the present invention.

FIG. 9 is a diagram illustrating an emission spectrum and an excitation spectrum in each case where using a different emission center material (InP, InAs, InSb), an emission center is added at a fixed heating temperature in Example 3 according to the present invention.

FIG. 10 is a diagram illustrating an emission spectrum and an excitation spectrum in each case where using InP as an emission center material, an emission center is added at a different heating temperature in Example 3 according to the present invention.

FIG. 11 is a diagram illustrating an emission spectrum and an excitation spectrum in the case where TlI is used as an emission center material in Example 4 according to the present invention.

FIG. 12 is a diagram illustrating an emission spectrum and an excitation spectrum in the case where using InI as emission center material, an In-added CsI columnar film is produced by a binary deposition method in Comparative Example 1.

### DESCRIPTION OF THE EMBODIMENTS

Preferred embodiments of the present invention will now be described in detail in accordance with the accompanying drawings.

The present invention provides a process for producing a scintillator of an emission center added CsI columnar film having high use efficiency of a material by producing a CsI columnar film by a deposition method, disposing an emission center material in a closed space, heating the emission center material to supply the emission center material into the closed space as a gaseous phase, and adding the emission center to the CsI columnar film by atomic diffusion.

Hereinafter, a process for producing a scintillator according to an embodiment of the present invention will be described in detail.

The process for producing a scintillator according to the embodiment of the invention is characterized by comprising producing a CsI columnar film formed of columnar CsI crystals by a deposition method, and adding an emission center to the CsI columnar film. In adding the emission center to the CsI columnar film, the CsI columnar film and an emission center material are disposed in a non-contact state in a closed space, the CsI columnar film is heated in the range of not less than a sublimation temperature or evaporation temperature of the emission center material and not more than a temperature at which a columnar shape of the CsI columnar film can be maintained, and the emission center material is heated at a temperature of not less than the sublimation temperature thereof.

The process for producing a scintillator according to the embodiment of the invention is also characterized in that in producing the CsI columnar film by the deposition method, using a deposition source having a region that completely covers a region projected from a film deposition region on a substrate to the deposition source, deposition is performed with a small distance between the deposition source and the film deposition region.

The process for producing a scintillator according to an embodiment of the invention is further characterized in that the film deposition region and the deposition source are closely disposed so that the minimum distance between the film deposition region and the deposition source may be not more than ⅓ of the length of the shorter side of the film deposition region.

Hereinafter, the details will be shown.

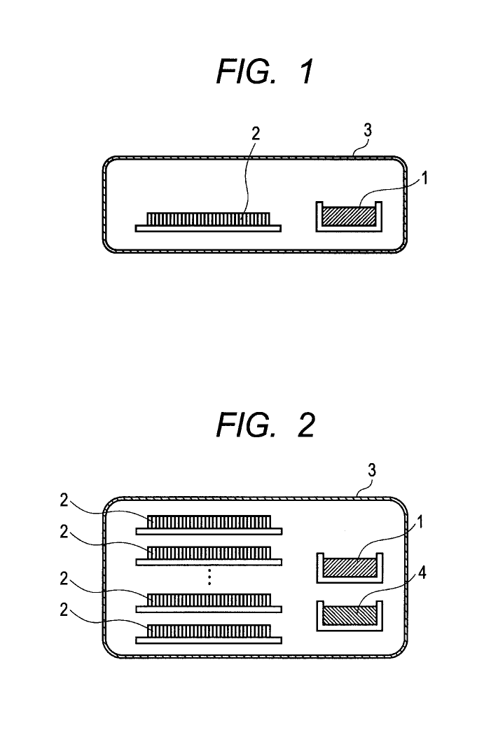

In a production process of the present invention a CsI columnar film 2 and an emission center material 1 are disposed in a non-contact state in a closed space 3, as shown in FIG. 1; the emission center material is heated at a temperature of not less than the sublimation temperature or evaporation temperature thereof to supply the emission center material into the closed space as a gaseous phase; and then, the emission center is uniformly added to the CsI film by atomic diffusion by heating the CsI columnar film in the temperature range in which the shape of the CsI columnar film can be maintained. In the conventional binary deposition method using two deposition sources, i.e., CsI and an emission center material, the materials emitted from the deposition sources to a region other than the film deposition region are wasted. For this reason, the use efficiency of the material deposited on the film deposition region was as low as 20% or less based on the supplied raw material. Examples of a method for improving use efficiency of a material include a close space sublimation method in which the distance between the deposition source and the film deposition region is made smaller to increase the amount of the raw material that enters the film deposition region. For example, a single deposition source can be disposed close to the film deposition region, and deposited on the film deposition region to produce CdTe, for example. In this method, a deposition source having a large enough area to cover the film deposition region is used while being disposed close to the film deposition region. For this reason, it is difficult to perform deposition using two or more deposition sources, and deposition using a single large deposition source is performed instead. Accordingly, in the case where the emission center added CsI is produced using the close space sublimation method, deposition is performed by using CsI and the emission center material as a single deposition source. However, the sublimation temperature of CsI is remarkably different from that of the emission center material, and therefore sublimation of the emission center material starts before sublimation of CsI starts. As a result, the emission center could not be uniformly added into the film. Thus, in these production processes, no emission center added CsI columnar film having high material use efficiency could be produced. However, the present invention is a process in which an emission center is diffusively added after the CsI columnar film not containing the emission center is produced, and therefore can increase the use efficiency of the emission center material. At this time, the temperature of each region in the closed space is controlled so that the emission center does not adhere to an unnecessary region in the closed space. Thereby, efficiency of the emission center material added to the CsI columnar film can be not less than 90%. Moreover, the CsI film to which the emission center is added is formed of a plurality of columnar shaped bodies separated from each other. Thereby, the emission center material can be added efficiently and uniformly. In addition, usually, while the emission center material is added only into the vicinity of the surface of the object to which the emission center is added, the CsI film as the object is formed of a plurality of columnar shaped bodies spaced from each other. For that reason, the surface area of the CsI film is large compared to the volume thereof. In spite of addition into the vicinity of the surface of the CsI film, a sufficient amount of the emission center material is added compared to the volume of the CsI film. The emission center material is also uniformly added in the depth (thickness) direction of the CsI film. Particularly, it can be confirmed that uniformity of the added material is at a level approximately equal to the level in the binary deposition method using two conventional deposition sources. The present invention is based on such our new knowledge.

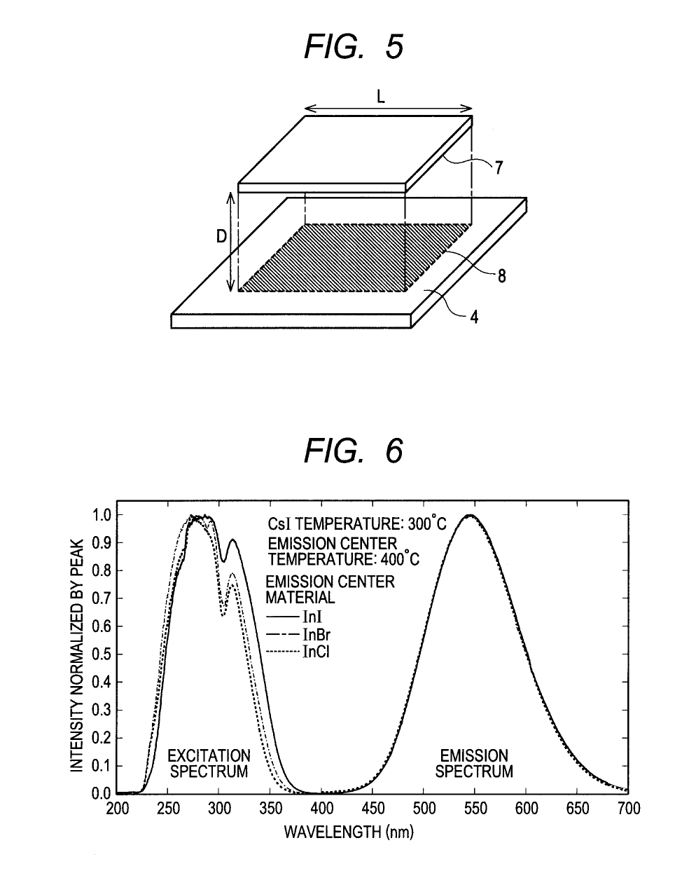

The use efficiency of the CsI raw material can also be increased by performing deposition with a small distance D between the CsI deposition source 4 and the film deposition region 7 as shown in FIG. 5 in order to obtain the CsI columnar film in the embodiment according to the present invention. Here, in order to ensure uniformity of the film thickness, when a region 8 projected from the film deposition region 7 to the CsI deposition source 4 is assumed, deposition is performed using a deposition source having a region that completely covers the region 8. Here, the use efficiency of the material according to a relationship between the deposition source and the film deposition region will be shown below in the case where the film deposition region has a shape of a simple square or rectangular and the shape is not such that one side is extremely long, for example, that the value obtained by dividing the length of the long side by the length of the shorter side is not less than 2. In the case where the size of the deposition source is small with respect to the length L of the shorter side of the film deposition region and it can be assumed that the deposition source is approximately a point, if D/L=2 wherein the length of the shorter side is L and the minimum distance between the film deposition region and the deposition source is D, the use efficiency of the material deposited from the deposition source onto the film deposition region is approximately 20%. In the case where D/L=1 by bringing the deposition source closer to the film deposition region, the use efficiency of the material increases to approximately 50%. In the case where D/L=⅓ by disposing the deposition source further closer to the film deposition region, the use efficiency of the material reaches to approximately 80%. In the embodiment according to the invention, in the case where deposition is performed by making the minimum distance D between the CsI deposition source and the film deposition region smaller, in order to obtain the use efficiency of the material of not less than 80%, is preferable such a disposition that the minimum distance D between the film deposition region and the deposition source is reduced to be not more than ⅓ of the length L of the shorter side of the film deposition region.

In the embodiment according to the present invention, the CsI raw material is also easily reused. Namely, in the conventional deposition method, the product after deposition is CsI containing the emission center because CsI and the emission center material are simultaneously deposited using the binary deposition sources. For that reason, in order to reuse the material wastefully emitted to a region other than the film deposition region, CsI and the emission center needed to be separated and purified. In the embodiment according to the invention, the CsI columnar film containing no emission center is produced, and subsequently the emission center is added. Accordingly, the CsI columnar film is first produced by using only CsI as the raw material. For that reason, CsI that reached a region other than the film deposition region includes no emission center as impurities, and therefore can be used again as a raw material as it is. Namely, the production process according to the embodiment of the invention also has such an advantage over the conventional binary deposition method that the CsI raw material is easily reused.

In the embodiment according to the present invention, the heating temperatures of the CsI columnar film and the emission center material and the pressure in the closed space are controlled separately when the emission center is added. Thereby, the emission center can be adjusted so as to have a desired concentration by the equilibrium between CsI and a gaseous phase of the emission center material, which is determined by the temperatures and the pressure. In the embodiment according to the present invention, the emission center in a gaseous phase is diffusively added to a plurality of columnar CsI crystals spaced from each other. Thereby, the emission center material permeates efficiently and uniformly from the bottom of the film to the upper portion thereof so that the emission center can be added efficiently. The CsI columnar film here refers to a film formed of innumerable columnar CsI crystals. A columnar CsI crystal is a CsI crystal whose aspect ratio of the diameter and the height (height/diameter) is not less than 10. In order to diffuse the emission center so as not to have an uneven concentration distribution within the columnar crystals in the diameter direction thereof, the diameter of each columnar CsI crystal is preferably not more than 100 μm.

Moreover, as shown in FIG. 2, a plurality of CsI columnar films 2 can be disposed in the closed space 3, and the emission center can be added at one time. Further, using an emission center material 4 of a different kind other than the emission center material 1, a plurality of emission centers can be simultaneously added.

The CsI columnar film is heated in the range of not less than a temperature at which the emission center material sublimates or evaporates and not more than a temperature at which CsI can maintain the columnar shape. In order to prevent the added emission center material from remaining on the CsI columnar film surface, the CsI columnar film is heated to not less than the temperature at which the emission center material sublimates or evaporates. In order to prevent reduction in the optical propagation function caused by fusion of columnar crystals, the CsI columnar film is heated in the range of not more than the temperature at which CsI can maintain the columnar shape. The emission center material is also heated at a temperature of not less than the sublimation temperature or evaporation temperature of the emission center material in order for the closed space to be filled with the evaporated emission center material. However, in order to incorporate the emission center into the CsI crystals, the CsI columnar film needs to be heated at a temperature of at least 150° C. or more.

As an In emission center material used in the present invention, indium halides such as InI, InBr and InCl, and III-V group In compounds such as InP, InAs and InSb can be used. In particular, in the case where InI is used as the emission center material, addition of In into the CsI columnar film progresses favorably without InI adhering to the surface of the CsI columnar film by employing a heating temperature of InI of not less than 200° C. at which sublimation of InI starts and a heating temperature of the columnar CsI film of not less than 200° C. and not more than 550° C.

Thallium halides such as TlI, TlBr and TlCl can be used as a Tl emission center material used in the present invention. In particular, in the case where TlI is used as the emission center material, addition of Tl into the CsI columnar film progresses favorably without TlI adhering to the surface of the CsI columnar film by employing a heating temperature of TlI of not less than 250° C. at which sublimation of TlI starts and a heating temperature of the columnar CsI film of not less than 250° C. and not more than 550° C.

In the embodiment according to the invention, the emission center can be added more efficiently by once evacuating the closed space to the 10⁻⁴-Pa range before heating the emission center material. For example, comparing the case where the emission center is added after the closed space is evacuated to the 10⁻²-Pa range with the case where the emission center is added after the closed space is filled with Ar at 0.2 Pa, the amount of the emission center to be added can be increased approximately 15% in the case where evacuation is performed.

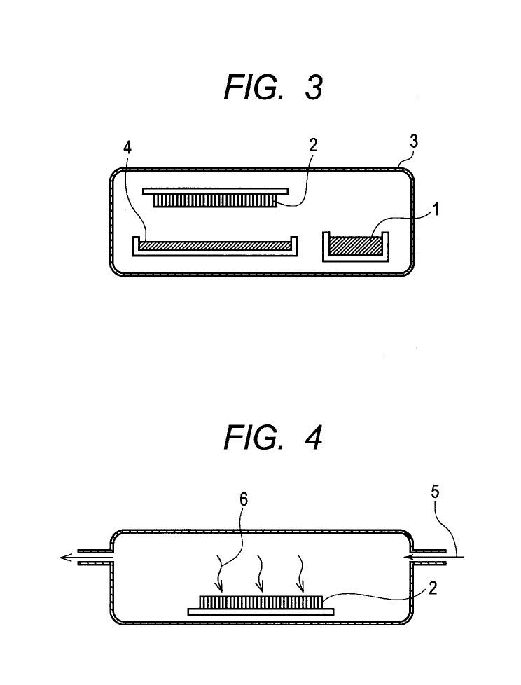

As shown in FIG. 3, in the embodiment according to the present invention, the step of producing the CsI columnar film by deposition and the step of diffusively adding the emission center can also be performed in the same closed space. In this case, the closed space 3 is filled with a process gas such as an Ar gas at the time of deposition, and filled with the evaporated emission center material at the time of adding the emission center. Namely, the CsI columnar film 2 is produced by heating the CsI deposition source 4 while introducing the Ar gas into the closed space 3 at a desired pressure. After the closed space 3 is once evacuated, the emission center material 1 is heated so that the closed space is filled with the evaporated emission center material to add the emission center to the CsI columnar film. This process is a process in which the material use efficiency of both CsI and the emission center material is increased.

As shown in FIG. 4, an organic gas containing the emission center can also be used as the emission center material. In this case, the organic gas 5 containing the emission center is allowed to flow with a carrier gas such as nitrogen, and decomposed by electrolytic dissociation or thermally decomposed in the vicinity of the CsI columnar film 2. Thereby, the emission center 6 is produced toward the CsI columnar film. In this case, the emission center is diffused in the CsI columnar film by heating the CsI columnar film at a temperature of not less than 300° C., so that the emission center added CsI columnar film can be produced. As the organic gas containing indium, a trimethylindium gas or a triethylindium gas can be used, for example.

### EXAMPLES

Hereinafter, the present invention will be described using Examples, but will not be limited to such Examples. Here, emission spectrums and excitation spectrums illustrated in FIG. 6 to FIG. 12 are each normalized by peak intensity.

### Example 1

The present Example is an example in which using an indium halide as the emission center material, In was added to a CsI columnar film produced by deposition.

First, a CsI columnar film was obtained by using CsI as a deposition raw material and depositing CsI on a film deposition region (50 mm×50 mm) on a substrate. First, a resistance heating crucible having a diameter of 20 mm was filled with CsI as a deposition source, and the distance between the deposition source and the film deposition region was adjusted at 100 mm in order to ensure uniformity of the film thickness. Subsequently, the inside of a deposition apparatus was once evacuated to the 10⁻⁴-Pa range. Then, an Ar gas was introduced into the deposition apparatus, and the pressure therein was adjusted at 0.2 Pa. CsI was deposited by heating the film deposition region to 200° C. and keeping the temperature while rotating the film deposition region at a rate of 5 rpm as well as by heating the resistance heating crucible to 730° C. Deposition was terminated when the film thickness of CsI reached 500 μm. The obtained CsI was observed by a scanning electron microscope. Then, CsI columnar crystals having a diameter of approximately 5 μm were observed, and a CsI columnar film having an aspect ratio of approximately 100 was obtained.

Using an indium halide, In was diffusively added to the CsI columnar film produced according to the above-mentioned steps. As shown in FIG. 1, the produced CsI columnar film 2 and the indium halide as the emission center material 1 were disposed in the closed space 3. As the indium halide, 3 g of InI, 3 g of InBr, and 3 g of InCl were used, respectively. Subsequently, the inside of the closed space was once evacuated to the 10⁻²-Pa range. Then, the emission center material was heated at a temperature of not less than the sublimation temperature thereof to fill the inside of the closed space with the evaporated emission center material, and simultaneously, the CsI columnar film was heated and the temperature thereof was kept for 30 minutes. Thus, the emission center was added to the CsI columnar film. At this time, of the respective supplied 3-g emission center materials, the amount of remaining InI was 2.80 g, the amount of remaining InBr was 2.83 g, and the amount of remaining InCl was 2.85 g. The use efficiency of each emission center material was not less than 90%.

FIG. 6 shows emission spectrums and excitation spectrums in the case where the CsI columnar film was heated at 300° C., the heating temperature of the emission center material was 400° C., and a different emission center material (InI, InBr or InCl) was used. Each spectrum is normalized with respect to peak intensity. From the results of the emission spectrums, in the case where the spectrum was normalized with respect to peak intensity, the emission wavelengths of InI, InBr and InCl showed the same shape having a peak at 544 nm when any one of InI, InBr and InCl was used as the emission center material. This is because the emission from In-added CsI is an emission from a level that In incorporated into the CsI crystals forms, and shows the same emission spectrum shape irrespective of the concentration of In. Although emission intensity of each sample is different, the emission spectrums having the same shape are obtained by normalization by peak intensity. In the case where InBr and InCl are used, even if Br or Cl which is a halogen of a different kind is added, the concentration of the halogen is low and not more than 0.1 mol %. Accordingly, addition of Br or Cl hardly influenced the emission spectrum. On the other hand, the excitation spectrum is correlated with the concentration of In incorporated into the CsI crystals. Accordingly, corresponding to the amount of In incorporated, InI, InBr and InCl each showed a different excitation spectrum.

As a result of an extensive study by the present inventors, it is supposed that in the excitation spectrum, intensity of the excitation band having a peak at 312 nm is correlated with a concentration of In activated in the CsI crystals, and that a sample showed a more efficient and stronger emission as the sample had a larger ratio of a peak intensity at 312 nm to that of the main excitation band at 270 nm. Namely, in this study, InI had the largest peak of the excitation band at 312 nm in the excitation spectrum, InBr had the second largest peak, and InCl had the third largest peak. With this, the emission luminance was increased accordingly. It is supposed that this is for the following reason: InI, which has the lowest sublimation temperature among the three, starts to sublimate at approximately 200° C.; therefore, during heating to 400° C., the concentration of InI that filled the inside of the closed space was higher than those of InBr and InCl; as a result, the amount of In diffused in the CsI columnar crystals was increased. From this, it turned out that it is optimal to use InI having a low sublimation temperature as the emission center material in the case where the heating temperatures of the emission center materials of InI, InBr and InCl are the same.

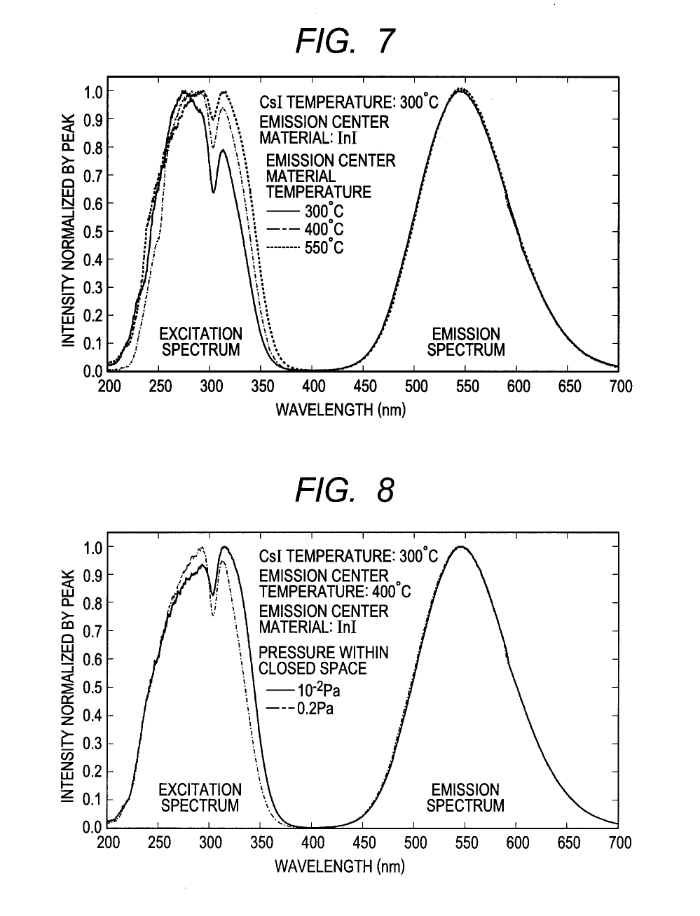

Next, FIG. 7 shows emission spectrums and excitation spectrums in the case where the CsI columnar film was heated at 300° C., InI was used as the emission center material, and the heating temperatures of InI were 300° C., 400° C. and 550° C. Because the emission spectrum does not change irrespective of the concentration of In in CsI as mentioned above, the emission spectrums did not change irrespective of the heating temperature of InI. On the other hand, in the excitation spectrums, the ratio of the peak intensity of the excitation band at 312 nm to that of the main excitation band at 270 nm was larger as the heating temperature of InI was higher. With this, the emission luminance was increased accordingly. It is supposed that this is because the concentration of InI that filled the inside of the closed space was higher as the heating temperature of InI was higher, and as a result, the amount of In diffused in the CsI columnar crystals was increased. From this, it turned out that the emission center can be diffused within the CsI columnar crystals at a higher concentration as the heating temperature of the emission center material is higher.

Further, FIG. 8 shows emission spectrums and excitation spectrums in the case where the CsI columnar film was heated at 300° C., InI was used as the emission center material to be heated at 400° C., and the pressure within the closed space 3 before heating was changed. With respect to the pressure, comparison was made between the case where the closed space was evacuated to the 10⁻²-Pa range and the case where the closed space was under an Ar atmosphere at 0.2 Pa. Because the emission spectrum does not change irrespective of the concentration of In in CsI as mentioned above, the emission spectrums did not change irrespective of difference in the pressure. On the other hand, in the excitation spectrum, the ratio of the peak intensity of the excitation band at 312 nm to that of the main excitation band at 270 nm was larger, so that it is suggested that In was added at a higher concentration as the pressure in the closed space was lower. With this, the emission luminance was increased accordingly. At this time, in the case where the closed space was evacuated to the 10⁻²-Pa range, In was added at a concentration approximately 15% higher than in the case where the closed space was under an Ar atmosphere at 0.2 Pa. From this, it turned out that the emission center can be diffused within the CsI columnar crystals at a higher concentration as the pressure within the closed space before heating is lower.

From the above-mentioned results, the emission center could be added to the CsI columnar film at a desired concentration by selecting an appropriate emission center material and adjusting the heating temperature of the emission center material and the pressure within the closed space.

As shown in FIG. 2, a plurality of CsI columnar films 2 can be disposed in the closed space 3, and the emission center can be added to the plurality of CsI columnar films 2 at one time. Further, using an emission center material 4 of a different kind other than the emission center material 1, the plurality of emission centers can be simultaneously added. As the emission center material 4 of a different kind, in addition to the indium compounds, thallium compounds and rare earth element compounds having an emission center different from that of the indium compounds can also be used.

The CsI columnar film produced by the deposition method as mentioned above and the emission center material were disposed in the closed space. The emission center material was heated to be supplied into the closed space as a gaseous phase, and the emission center was added to the CsI columnar film by atomic diffusion. Thus, a process for producing a scintillator of an emission center added CsI columnar film with high use efficiency of a material could be provided.

### Example 2

The present Example is an example in which using an indium halide as the emission center material, In was added to a CsI columnar film produced by the close space sublimation method with a smaller distance between the deposition source and the film deposition region. First, a CsI columnar film was obtained by using CsI as a deposition raw material and depositing CsI onto the film deposition region (50 mm×50 mm) on a substrate.

Hereinafter, description will be made using FIG. 5. In the present Example, the film deposition region 7 measures 50 mm×50 mm, and the film deposition region 7 and the CsI deposition source 4 face each other in parallel. Accordingly, the region 8 projected from the film deposition region 7 to the CsI deposition source 4 also measures 50 mm×50 mm. Then, the CsI deposition source 4 measuring 60 mm×60 mm was disposed directly under the film deposition region 7 so as to completely cover the region 8 measuring 50 mm×50 mm. The distance D between the CsI deposition source 4 and the film deposition region 7 was 15 mm so as to be not more than ⅓ of the length L (=50 mm) of the shorter side of the film deposition region 7. Thus, the film deposition region 7 and the CsI deposition source 4 were closely disposed such that the distance D between the film deposition region 7 and the CsI deposition source 4 was not more than ⅓ of the length L of the shorter side of the film deposition region 7. Thereby, the amount of CsI as the raw material deposited on the film deposition region could reach not less than 80%. Subsequently, the inside of the deposition apparatus was once evacuated to the 10⁻⁴-Pa range, and then an Ar gas was introduced thereinto and the pressure thereof was adjusted to 0.2 Pa. The film deposition region 7 was heated to 200° C., and the temperature was kept. The CsI deposition source 4 was heated to 730° C. to deposit CsI. Deposition was terminated when the film thickness of CsI reached 500 μm.

The obtained CsI was observed by a scanning electron microscope. Then, CsI columnar crystals having a diameter of approximately 5 μm were observed, and a CsI columnar film having an aspect ratio of approximately 100 was obtained. In Example 1, the amount of CsI deposited on the film deposition region is approximately 20% based on the supplied material. On the other hand, in the present Example, approximately 85% of CsI was deposited on the film deposition region to produce the CsI columnar film with high material use efficiency. Because the CsI columnar film produced according to the above-mentioned steps has the same shape as that of the CsI columnar film produced in Example 1, the In-added CsI columnar film could be produced by diffusively adding In according to the same steps as those of Example 1.

As mentioned above, the CsI columnar film produced by the close space sublimation method in which the distance between the deposition source and the film deposition region was made smaller and the emission center material were disposed in the closed space. Then, the emission center material was heated to be supplied into a closed space as a gaseous phase, and the emission center was added to the CsI columnar film by atomic diffusion. Thus, a process for producing a scintillator of an emission center added CsI columnar film with high use efficiency of the material could be provided.

### Example 3

The present Example is an example in which using an indium compound of a III-V group element, i.e., any one of InP, InAs and InSb, as the emission center material, In was added to a CsI columnar film produced by deposition.

First, the CsI columnar film was produced by a deposition method similarly to the case of Example 1. Subsequently, the produced CsI columnar film and the Indium compound of an III-V group element as the emission center material were disposed in a closed space. As the indium compound, 5 g of InP, 5 g of InAs, and 5 g of InSb were used, respectively. Subsequently, the inside of the closed space was once evacuated to the 10⁻²-Pa range. Then, the emission center material was heated at a temperature of not less than the sublimation temperature thereof, and the inside of the closed space was filled with the evaporated emission center material. Simultaneously, the CsI columnar film was heated and the temperature was kept for 30 minutes. Thereby, the emission center was added to the CsI columnar film. At this time, of the respective supplied 5-g emission center materials, the amount of remaining InP was 4.60 g, the amount of remaining InAs was 4.63 g, and the amount of remaining InSb was 4.63 g. Each use efficiency of the emission center material was not less than 90%.

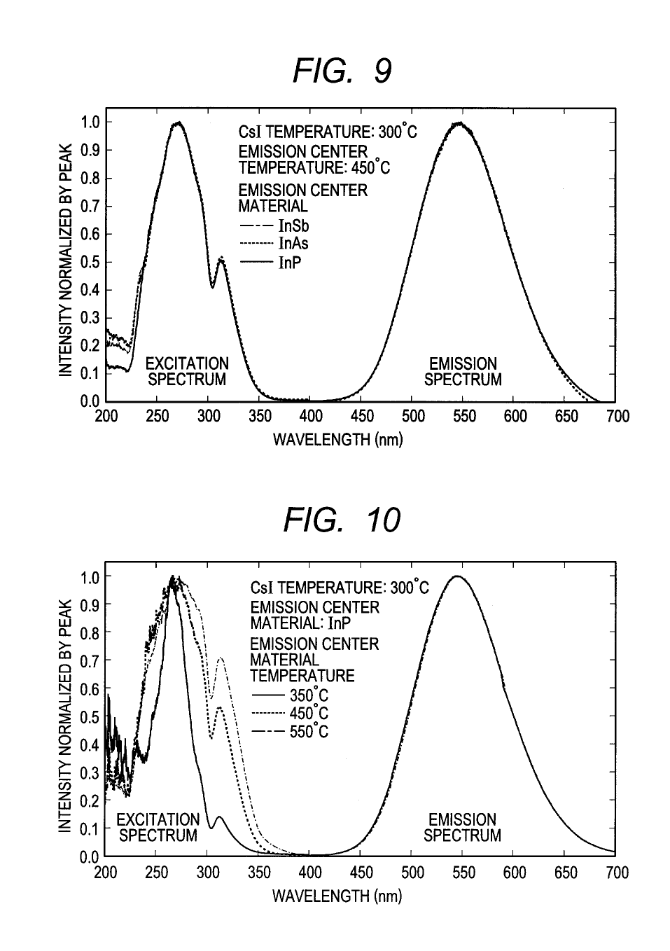

FIG. 9 shows emission spectrums and excitation spectrums in the case where the CsI columnar film was heated at 300° C., the heating temperature of the emission center material was 450° C., and the three different emission center materials of InP, InAs and InSb were each used. From the results of the emission spectrums, the emission wavelengths of InP, InAs and InSb showed the same emission spectrum having a peak at 544 nm in each case where an emission center material of InP, InAs or InSb was used. In each case where InP, InAs or InSb was used, an element of P, As or Sb neither of which directly contributes to emission was simultaneously added. However, the emission spectrum was not influenced because the concentration of such added element was low and not more than 0.1 mol %. The peak of the excitation band at 312 nm in the excitation spectrum was hardly different among the cases of InP, InAs and InSb. From this, it turned out that InP, InAs and InSb can be equally used as the emission center material even when any of InP, InAs and InSb is used as the emission center material.

Next, FIG. 10 shows emission spectrums and excitation spectrums in the case where the CsI columnar film was heated at 300° C., InP was used as the emission center material, and the heating temperatures of InP were 350° C., 450° C. and 550° C. The emission spectrum did not change irrespective of the heating temperature of InP. On the other hand, in the excitation spectrum, the ratio of the peak intensity of the excitation band at 312 nm to that of the main excitation band at 270 nm was larger as the heating temperature of InP was higher. With this, the emission luminance was increased accordingly. It is supposed that this is for the following reason: because InP rapidly starts to decompose at a temperature around 400° C., the concentration of InP that filled the inside of the closed space was higher as the heating temperature was higher; as a result, the amount of In diffused in the CsI columnar crystals was increased. From this, it turned out that the emission center can be diffused in the CsI columnar crystals at a higher concentration as the heating temperature of the emission center material is higher.

As mentioned above, the CsI columnar film produced by the deposition method and the Indium compound of a III-V group element as the emission center material were disposed in the closed space. The emission center material was heated to be supplied into the closed space as a gaseous phase, and In as the emission center was added to the CsI columnar film by atomic diffusion. Thus, the In-added CsI columnar film could be produced.

### Example 4

The present Example is an example in which using thallium iodide (TlI) that is a thallium halide as the emission center material, Tl was added to the CsI columnar film produced by deposition.

First, a CsI columnar film was produced by a deposition method similarly to the case of Example 1. Subsequently, the produced CsI columnar film and 3 g of TlI as the emission center material were used and disposed in a closed space. Then, the inside of the closed space was once evacuated to the 10⁻²-Pa range. Subsequently, TlI as the emission center material was heated at 350° C. higher than the sublimation temperature thereof, and the inside of the closed space was filled with the evaporated TlI. Simultaneously, the CsI columnar film was heated at 300° C., and the temperature was kept for 30 minutes. Thereby, Tl was added to the CsI columnar film as the emission center. At this time, of the supplied 3-g emission center material, the amount of remaining TlI was 2.80 g, and the use efficiency of the emission center material was not less than 90%.

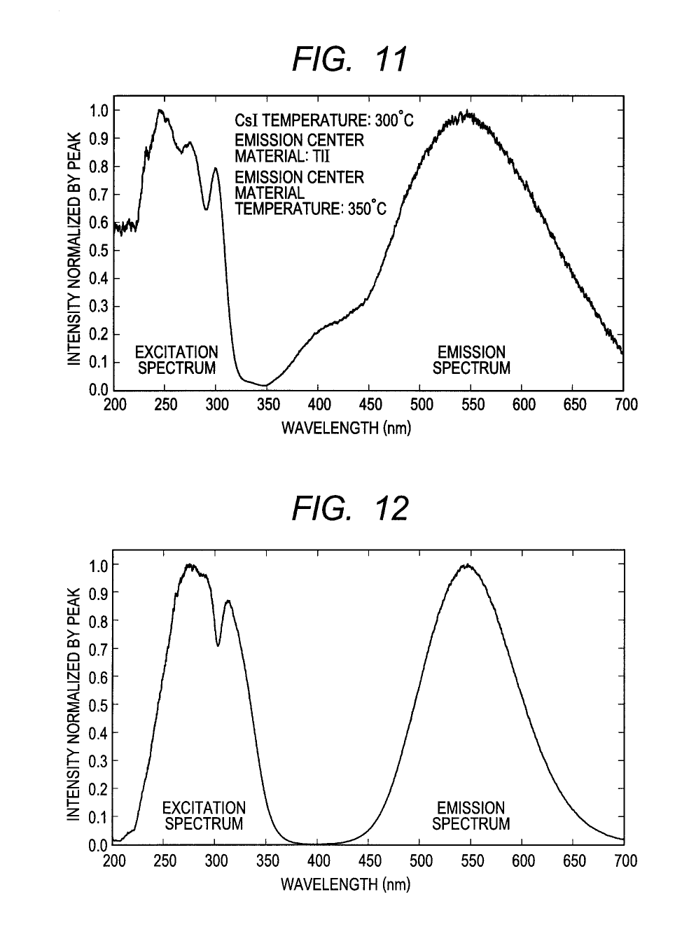

FIG. 11 shows the results of an emission spectrum and an excitation spectrum. Emission showed peaks at 540 nm and 410 nm, and the main excitation bands were formed at 275 nm and at 300 nm. This is an emission comparable to that of Tl-added CsI produced by simultaneously depositing CsI and TlI. Tl-added CsI changes the emission wavelength thereof according to the concentration of Tl in the CsI crystals, and shows the emission at longer wavelengths as the Tl concentration is higher. For that reason, in the present Example, when the time to heat the CsI columnar film and keep the temperature thereof in the evaporated TlI was longer, the emission wavelength was shifted to longer wavelengths, and the emission peak was shown around 565 nm.

As mentioned above, the CsI columnar film produced by the deposition method and TlI as the emission center material were disposed in the closed space, the emission center material was heated to be supplied into the closed space as a gaseous phase, and Tl as the emission center was added to the CsI columnar film by atomic diffusion. Thus, the Tl-added CsI columnar film could be produced.

### Example 5

The present Example is an example in which the step of producing the CsI columnar film by the close space sublimation method and the step of diffusively adding the emission center were performed in the same closed space.

As shown in FIG. 3, the CsI deposition source 4 and InI as the emission center material 1 were disposed in the closed space 3. First, the closed space 3 was filled with an Ar gas of 0.2 Pa. Similarly to the case of Example 1, the CsI deposition source 4 was heated by the close space sublimation method to produce the CsI columnar film 2. During depositing the CsI deposition source 4 into a film, the emission center material 1 was covered to prevent scattered CsI from adhering to the emission center material 1. Then, the inside of the closed space 3 was evacuated to the 10⁻²-Pa range. Subsequently, InI as the emission center material was heated at 500° C., and the inside of the closed space was filled with the evaporated InI. Simultaneously, the CsI columnar film was heated to 300° C., and the temperature was kept for 30 minutes. Thereby, In was added to the CsI columnar film as the emission center.

As mentioned above, the step of producing the CsI columnar film and the step of diffusively adding the emission center were performed in the same closed space and thereby the emission center added CsI columnar film could be produced.

### Comparative Example 1

This is a Comparative Example in which using CsI and InI as a deposition source, an In-added CsI columnar film was produced by an ordinary binary deposition method.

First, two resistance heating crucibles having a diameter of 20 mm were prepared. One of the crucibles was filled with 100 g of CsI, and the other was filled with 5 g of InI, separately. Using the two crucibles as the deposition sources, deposition was conducted onto a film deposition region (50 mm×50 mm) on a substrate. In this case, in order to ensure film thickness uniformity and concentration uniformity of the emission center, the distance between the deposition source and the film deposition region was set to 200 mm. Once the inside of the deposition apparatus was evacuated to the 10⁻⁴-Pa range, an Ar gas was introduced and the pressure thereof was adjusted at 0.2 Pa. The film deposition region was heated to 200° C. while the film deposition region was rotated at a rate of 5 rpm, and the temperature was kept. CsI was heated to 730° C. and InI was heated to 250° C. to perform deposition. Deposition was terminated when the film thickness reached 500 μm. Thus, an In-added CsI columnar film was produced. At this time, of the supplied raw materials, the amount of the materials deposited on the film deposition region was approximately 16% of the supplied raw materials.

FIG. 12 shows the results of an emission spectrum and an excitation spectrum. The emission spectrums and excitation spectrums of the In-added CsI columnar films in Example 1 and Example 2 produced according to the process of the present invention showed the emission characteristics comparable to the result shown in FIG. 12. From this, it turned out that the emission center added CsI columnar film produced using the process for diffusively adding the emission center after the CsI columnar film is produced according to the present invention showed the emission function comparable to that in the case where the CsI columnar film is produced by the ordinary binary deposition method.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-056616, filed Mar. 12, 2010, which is hereby incorporated by reference herein in its entirety.

What is claimed is:

1. A process for producing a scintillator, comprising the steps of:
producing a CsI columnar film formed of columnar CsI crystals by a deposition method; and
adding an emission center to the CsI columnar film by disposing the CsI columnar film and an emission center material in a non-contact state in a closed space, heating the CsI columnar film in the range of not less than a sublimation temperature or evaporation temperature of the emission center material and not more than a temperature at which a columnar shape of the CsI columnar film can be maintained, and heating the emission center material at a temperature of not less than a sublimation temperature or evaporation temperature thereof.

2. The process for producing a scintillator according to claim 1, wherein in the step of producing a CsI columnar film by a deposition method, using a deposition source having a region that completely covers a region projected from a film deposition region on a substrate to the deposition source, deposition is performed with a small distance between the deposition source and the film deposition region.

3. The process for producing a scintillator according to claim 2, wherein the film deposition region and the deposition source are disposed so that a minimum distance between the film deposition region and the deposition source is set to not more than ⅓ of a length of a shorter side of the film deposition region.

4. The process for producing a scintillator according to claim 1, wherein the step of producing a CsI columnar film by a deposition method and the step of adding an emission center to the CsI columnar film are performed in the same closed space.

5. The process for producing a scintillator according to claim 1, wherein the emission center material is one or more In compounds selected from the group consisting of InI, InBr, InCl, InP, InAs and InSb.

6. The process for producing a scintillator according to claim 1, wherein the emission center material is one or more Tl compounds selected from the group consisting of TlI, TlBr and TlCl.

7. The process for producing a scintillator according to claim 5, wherein the emission center material is InI, a heating temperature of the InI is not less than 200° C., and a heating temperature of the columnar CsI film is not less than 200° C. and not more than 550° C.

8. The process for producing a scintillator according to claim 6, wherein the emission center material is TlI, a heating temperature of the TlI is not less than 250° C., and a heating temperature of the columnar CsI film is not less than 250° C. and not more than 550° C.
